(19) United States
(12) Patent Application Publication
(10) Pub. No.: US 2020/0089714 A1
(43) Pub. Date: Mar. 19, 2020

(54) METHOD AND SERVER FOR INDEXING WEB PAGE IN INDEX

(71) Applicant: YANDEX EUROPE AG, Luzern (CH)

(72) Inventors: Sergey Vasilievich MELNIK, Volgograd (RU); Yegor Andreevich FILONOV, Ozersk (RU); Ivan Vladimirovich KOROSTELEV, Moscow (RU)

(21) Appl. No.: 16/371,895

(22) Filed: Apr. 1, 2019

(30) Foreign Application Priority Data
Sep. 14, 2018 (RU) 2018132717

(51) Int. Cl. G06F 16/951; G06N 20/00; G06F 16/953; H04L 29/08

(52) U.S. Cl. CPC G06F 16/951; H04L 67/1002; G06F 16/953; G06N 20/00

(57) ABSTRACT

A method and server for indexing a page is disclosed. The method includes identifying recent data associated with the page and generating, via an MLA, a score for the page based on the recent data which is indicative of usefulness of the page as a search result of a search engine. The MLA has been trained based on a training page having data at a first moment in time and data at a second moment in time. The method also includes selectively adding the page to one of a real-time indexing queue and a postponed indexing queue based on a comparison between the score and a threshold. If the score is below the threshold, the page is added to the postponed indexing queue. If the score is above the threshold, the page is added to the real-time indexing queue. Pages in the real-time indexing queue are indexed in real-time.

### CROSS-REFERENCE

The present application claims priority from Russian Patent Application No. 2018132717, entitled “Method and Server for Indexing Web Page in Index,” filed Sep. 14, 2018, the entirety of which is incorporated herein by reference.

### FIELD

The present technology relates to search engine indexing and, more particularly, to methods and servers for indexing a web page in an index.

### BACKGROUND

Today's large datacenters manage collections of data comprising billions of data items. In large collections like these, searching for a particular item that meets conditions of a given search query is a task that can take considerable (and noticeable) time and consumes a considerable amount of computing resources. Query response time can be critical in many applications, either due to specific technical requirements, or because of high expectations of users. Therefore, various solutions have been proposed for reducing search query execution times.

Typically, to build a search-efficient data collection management system, data items are “indexed” according to some or all of the terms contained in the document, which terms can potentially “meet” one or more future search query terms. A so-called “inverted index” of the data collection is maintained and updated by the system, to be then used in execution of a given search query. The inverted index comprises a plurality of “posting lists”, where every posting list corresponds to a term and contains references to data items comprising that search term.

Using an example of a general search engine, data items may take the form of digital documents, such as web pages, and indexed terms may be individual words or some of their most often used combinations. The inverted index may thus comprise one posting list per every word present in at least some of the digital documents.

It is also known to employ vertical search engines, which are search engines dedicated for searching digital documents having specific topics or types such as, images, news, videos and others. Vertical search engines may be configured to use respective indexes adapted or designed for storing data about specific digital documents. For example, an image vertical search engine can be configured to use an index storing data about image files. In another example, a news vertical search engine can be configured to use an index storing data about “fresh” or otherwise newly accessible digital documents. This may allow addressing a large variety of queries and providing relevant results in a timely manner.

The indexing operation, the process during which a given index is built, is commonly known to be a computationally consuming task due to the large number of digital documents to be indexed and therefore requires, as previously mentioned, large datacenters. However, real life datacenters are expensive to maintain and have a limited amount of processing power that can be allocated in real-time for indexation as they are generally used by their operators for a large variety of computational processes.

### SUMMARY

Developers of the present technology have appreciated certain technical drawbacks associated with existing indexing systems. Conventional indexing systems are focused on time-efficient algorithms for retrieving results from indexes or, in other words, on reducing an amount of time between the receipt of a query and provision of results. Advances in indexing operations are generally directed to designing index structures that allow quick “look up” procedures for retrieving a list of digital documents that are presumed to satisfy a given search query.

However, in some cases, there is an underlying problem of relevancy or quality of the digital documents retrieved from an index for satisfying a query. Even if the index structure has been designed so as to allow extremely quick retrieval of digital documents for a given search query, which in turn allows a quick provision of these digital documents to the user, in some cases, these documents may not necessarily be the best digital documents for satisfying the search query.

For example, if the user is interested in breaking news about a very recent event, even though (i) some digital documents can be quickly provided upon his/her request and (ii) these digital documents may be somewhat relevant for the query, the user will most probably not be satisfied with them because they have been indexed prior to the very recent event and inherently are not the best digital documents that are available on the web for satisfying the user interest in the very recent event.

It is an object of the present technology to ameliorate at least some of the inconveniences present in the prior art. Developers of the present technology envisaged a system that may allow reducing an amount of time between (i) a moment of creation, or otherwise the moment of accessibility, of content of a given digital document on the web and (ii) the moment at which the given digital document is indexed. Such a system aims to address a need of providing users searching for information about recent events with satisfactory digital documents who's content is also recent.

It is contemplated that the system as envisaged by the developers of the present technology may also allow managing the limited amount of processing power that can be allocated in real-time for indexation by selectively prioritizing indexing of some digital documents before others. Indeed, the urgency of indexing some digital documents such as web pages associated with new information (e.g., news articles) may be higher than indexing other digital documents such as web pages associated with old information (e.g., history literature).

It is contemplated that the system as envisaged by the developers of the present technology may also allow managing the limited amount of processing power that can be allocated in real-time for indexing by selectively postponing the indexing of some digital documents to a later time when a higher amount of processing power can be allocated for indexing. For example, the system may determine that some digital documents may be less useful to users of a search engine as fresh search results than others and, thus, may selectively postpone their indexing in order to prioritize indexing of more useful digital documents.

It is contemplated that the system as envisaged by the developers of the present technology may also provide a scalable solution for real-time indexing of digital documents by monitoring the amount of processing power that can be allocated in real-time for the indexing operation and, in response, adapting the selective prioritization of digital documents for indexing. For example, different entities or operators may have different datacenter facilities having different amounts of processing power to begin with and, therefore, providing a scalable solution that can be adapted to different datacenter facilities may be desirable.

It should be understood that the amount of processing power that can be allocated in real-time for the indexing can vary depending on many factors. The scalability of the present technology may allow adapting the selective prioritization procedure such that, when the amount of processing power which can be allocated in real-time for the indexing operation grows, the number of digital documents that are selectively indexed in real-time likewise grows. By the same token, the scalability of the present technology may allow adapting the selective prioritization procedure such that, when the amount of processing power which can be allocated in real-time for the indexing procedure diminishes, the number of digital documents that are selectively indexed in real-time likewise diminishes.

In a first broad aspect of the present technology, there is provided a method of indexing a web page in an index. The index is hosted in a datacenter system communicatively coupled with a triage server. The index is for providing indications of possible search results to a search engine. The method executable by the triage server. The method comprises identifying, by the triage server executing a crawler application, recent data associated with the web page to be indexed. The method comprises generating, by the triage server executing a machine learning algorithm (MLA), an importance score for the web page based on the recent data associated with the web page where the importance score is indicative of usefulness of the web page as a search result. The MLA has been trained based on a training set that comprises: (i) a training vector indicative of data associated with a training web page at a first moment in time after creation of content on the training web page, and (ii) a label indicative of usefulness of the training web page as a search result and based on data associated with the training web page at a second moment in time and where the second moment in time is later in time than the first moment in time. The method comprises selectively adding, by the triage server, the web page to one of (i) a real-time indexing queue and (ii) a postponed indexing queue based on a comparison between the importance score of the web page and a triage threshold such that: if the importance score is below the triage threshold, the web page is added to the postponed indexing queue for postponing the indexing of the web page, and if the importance score is above the triage threshold, the web page is added to the real-time indexing queue for indexing of the web page in real-time.

In some embodiments of the method, the recent data is associated with the web page at a given moment in time after creation of content on the web page.

In some embodiments of the method, the recent data is associated with the web page at a given moment in time after the web page has been crawled by the crawler application.

In some embodiments of the method, the importance score is indicative of usefulness of the web page as a fresh search result.

In some embodiments of the method, the training vector is based on sparse data associated with the training web page available at the first moment in time.

In some embodiments of the method, web pages added to the real-time indexing queue for indexing the web pages in real-time are indexed independently from web pages added to the postponed indexing queue.

In some embodiments of the method, web pages added to the real-time indexing queue for indexing the web pages in real-time are indexed before any other web page added to the postponed indexing queue.

In some embodiments of the method, web pages added to either one of (i) a real-time indexing queue and (ii) postponed indexing queue are queued with respect to one another according to their respective importance scores.

In some embodiments of the method, the web page is one of a new web page and an updated web page.

In some embodiments of the method, the new web page is a given web page that has not been previously indexed. Usefulness of the new web page as the search result is more likely higher than usefulness of an old web page as the search result. The old web page has been previously indexed.

In some embodiments of the method, the updated web page is an updated version of an old web page. The updated web page has not been previously indexed. The old web page has been previously indexed. Usefulness of the updated web page as the search result is more likely higher than usefulness of the old web page as the search result.

In some embodiments of the method, in response to the web page being the new web page, the importance score is weighted to ensure it is above the triage threshold, such that the new web page is added to the real-time indexing queue for indexing of the new web page in real-time.

In some embodiments of the method, the method further comprises: transmitting, by the triage server, data indicative of the web pages in the real-time indexing queue to the datacenter system for real-time indexing, and transmitting, by the triage server, data indicative of the web pages in the postponed indexing queue to the datacenter system for postponed indexing.

In some embodiments of the method, the triage server implements a load balancing algorithm for balancing processing load of the datacenter system, and where the method further comprises determining, by the triage server employing the load balancing algorithm, that the datacenter system has an available amount of processing power for executing real-time indexing.

In some embodiments of the method, the triage threshold is dependent on the available amount of processing power for executing real-time indexing.

In some embodiments of the method, in response to determining, by the triage server employing the load balancing algorithm, that the available amount of processor power for executing real-time indexing has changed, the method comprises adjusting, by the triage server, the triage threshold.

In some embodiments of the method, the recent data comprises at least one of: creation time of the web page, number of visits to a URL of the web page, number of inbound hyperlinks to the web page, number of outbound hyperlinks from the web page, and type of content of the web page.

In another broad aspect of the present technology, there is provided a server for indexing a web page in an index. The index is hosted in a datacenter system communicatively coupled with the server. The index for providing indications of possible search results to a search engine. The server is configured to execute a crawler application and a machine learning algorithm (MLA). The server is configured to identify, by executing the crawler application, recent data associated with the web page to be indexed. The server is configured to generate, by executing the MLA, an importance score for the web page based on the recent data associated with the web page and where the importance score is indicative of usefulness of the web page as a search result. The MLA has been trained based on a training set that comprises: (i) a training vector indicative of data associated with a training web page at a first moment in time after creation of content on the training web page, and (ii) a label indicative of usefulness of the training web page as a search result and based on data associated with the training web page at a second moment in time and where the second moment in time is later in time than the first moment in time. The server is configured to selectively add the web page to one of (i) a real-time indexing queue and (ii) a postponed indexing queue based on a comparison between the importance score of the web page and a triage threshold such that: if the importance score is below the triage threshold, the web page is added to the postponed indexing queue for postponing the indexing of the web page, and if the importance score is above the triage threshold, the web page is added to the real-time indexing queue for indexing of the web page in real-time.

In some embodiments of the server, the triage threshold is dependent on an available amount of processing power of the datacenter system for executing real-time indexing.

In some embodiments of the server, the server is configured to the web page is one of: a new web page, and an updated web page.

In the context of the present specification, a “server” is a computer program that is running on appropriate hardware and is capable of receiving requests (e.g., from devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “device” is any computer hardware that is capable of running software appropriate to the relevant task at hand. Thus, some (non-limiting) examples of devices include personal computers (desktops, laptops, netbooks, etc.), smartphones, and tablets, as well as network equipment such as routers, switches, and gateways. It should be noted that a device acting as a device in the present context is not precluded from acting as a server to other devices. The use of the expression “a device” does not preclude multiple devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts a system suitable for implementing non-limiting embodiments of the present technology;

FIG. 2 depicts a schematic representation of data associated with a given web page which may be stored in a processing database of the system of FIG. 1, as contemplated in some non-limiting embodiments of the present technology;

FIG. 3 depicts a single iteration of a training phase and a single iteration of an in-use phase of an Machine Learning Algorithm (MLA) of a triage server of the system of FIG. 1, as contemplated in some non-limiting embodiments of the present technology;

FIG. 4 depicts a schematic representation of a triage threshold, a real-time indexing queue and a postponed indexing queue which are suitable for implementing non-limiting embodiments of the present technology; and

FIG. 5 is a schematic block diagram illustration of a flow chart of a method of indexing a web page, as contemplated in some non-limiting embodiments of the present technology.

### DETAILED DESCRIPTION

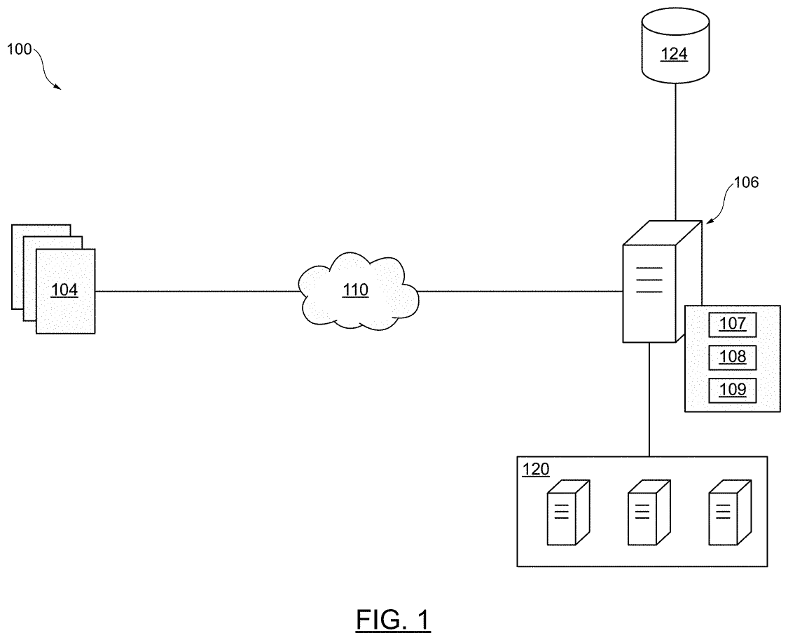

Referring to FIG. 1, there is shown a schematic diagram of a system 100, the system 100 being suitable for implementing non-limiting embodiments of the present technology. It is to be expressly understood that the system 100 as depicted is merely an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 100 may also be set forth below. This is done merely as an aid to understanding, and, again, not to define the scope or set forth the bounds of the present technology.

These modifications are not an exhaustive list, and, as a person skilled in the art would understand, other modifications are likely possible. Further, where this has not been done (i.e., where no examples of modifications have been set forth), it should not be interpreted that no modifications are possible and/or that what is described is the sole manner of implementing that element of the present technology. As a person skilled in the art would understand, this is likely not the case. In addition it is to be understood that the system 100 may provide in certain instances simple implementations of the present technology, and that where such is the case they have been presented in this manner as an aid to understanding. As persons skilled in the art would understand, various implementations of the present technology may be of a greater complexity.

Generally speaking, the system 100 is configured to manage an indexing operation of digital documents, such as web pages for example, in an index. How the index is structured, how indexing of data of a given digital document is executed and how digital documents can be located in the index is generally described in a co-owned US Patent Application Publication US 2016/0070734, published on Mar. 10, 2016 and entitled “METHODS AND SYSTEMS FOR INDEXING REFERENCES TO DOCUMENTS OF A DATABASE AND FOR LOCATING DOCUMENTS IN THE DATABASE”, the content of which is incorporated herein by reference in its entirety. Therefore, for sake of brevity only, the structure of the index hosted by the system 100 will not be described at length herein.

Broadly speaking, the system 100 can be said to be configured to determine what digital documents are indexed and when. In other words, the system 100 is configured to manage (i) real-time indexing of some digital documents and (ii) a postponed indexing of other digital documents. To that end, the system 100 has access to a plurality of digital documents 104 . The digital documents 104 can be, for example, discovered (also known as “crawled”) on the Internet, as is known in the art. The system 100 comprises a communication network 110, a triage server 106, a processing database 124 and a datacenter system 120. How various components of the system 100 are configured for managing (i) real-time indexing of some digital documents and (ii) postponed indexing of other digital documents will now be described.

### Plurality of Digital Documents

The plurality of digital documents 104 may be hosted by various computer systems accessible over the Web, for example. The nature of the plurality of digital documents 104 is not particularly limited. In the context of the present specification, the plurality of digital documents 104 may also be referred to as “a plurality of web pages”, “web pages”, “web documents” or simply “documents”. However, it is contemplated that a given one of the plurality of digital documents 104 may be any form of structured digital information that can be retrieved or accessed via a corresponding Universal Resource Locator (URL), without departing from the scope of the present technology.

Broadly speaking, a given one of the plurality of digital documents 104 may contain one or more sentences. A given one of the plurality of digital documents 104, can be, for example, a web page containing text and/or images (such as, for example, a news article recently published and relating to some breaking news). Another given one of the plurality of digital documents 104, can be, as another example, a digital version of a book (such as, for example, a digital version of “Pride and Prejudice” by Jane Austin). Another given one of the plurality of digital documents 104, can be, as another example, an article on Wikipedia™, which can be updated from time to time.

It is contemplated that at least some of the plurality of digital documents 104 may have been recently created (or updated) or otherwise may have been recently made accessible over the Web. Indeed, a very large number of web pages are created or otherwise made accessible over the Web everyday and, as such, there may be a need to index at least some of these web pages so as to provide their content to users of a given search engine.

It should be noted that at least some of the plurality of digital documents 104 may be “fresh” web pages, such as web pages having fresh content that is likely to be updated relatively frequently (e.g., weather), while at least some others of the plurality of digital documents 104 may be “stagnant” web pages, such as web pages having stagnant content that is less likely to change or be changed with less frequent intervals (e.g., Wikipedia article on the Canadian constitution). On the one hand, usefulness of fresh content to users of a given search engine usually (i) peaks close to the moment of its creation and (ii) drops after some period of time. On the other hand, usefulness of stagnant content to users of the given search engine usually (i) is lower near the moment of its creation than usefulness of fresh content near the moment of its creation but (ii) is somewhat constant throughout time.

It is contemplated that at least some of the plurality of the web pages 104 may have been previously indexed, while at least some others of the plurality of digital documents 104 may not have been previously indexed. For example, the plurality of digital documents 104 may comprise “new” web pages which have not been previously indexed. In another example, the plurality of digital documents 104 may comprise “old” web pages which have been previously indexed. In yet another example, the plurality of digital documents 104 may comprise “updated” web pages which are, in a sense, “updated” versions of old web pages, where the content of the updated version of the web page is different from the content of the old version of the web page which has been previously indexed.

Indeed, as it will be further described below with respect to the triage server 106, at least some of the plurality of digital documents 104 may have been previously “crawled” and data about them may have been previously “fetched” for indexing. It is also contemplated that at least some of the plurality of digital documents 104 may have been “taken down” or otherwise became unavailable since their indexing.

### Communication Network

In the illustrative example of the system 100, the plurality of digital documents 104 is accessible to the triage server 106 via the communication network 110. In some non-limiting embodiments of the present technology, the communication network 110 can be implemented as the Internet. In other non-limiting embodiments of the present technology, the communication network 110 can be implemented differently, such as any wide-area communication network, local-area communication network, a private communication network and the like.

Merely as an example and not as a limitation, a communication link between the plurality of digital documents 104 and the triage server 106 can be implemented as a wireless communication link (such as but not limited to, a 3G communication network link, a 4G communication network link, Wireless Fidelity, or WiFi® for short, Bluetooth® and the like). In other examples, the communication link can be either wireless (such as Wireless Fidelity, or WiFi® for short, Bluetooth® or the like) or wired (such as an Ethernet based connection).

### Datacenter System

Generally speaking, a datacenter system 120 is a cluster of computer systems, such as server computers for example, that provides computer processing power for various computational processes that an operator configures it to perform. As an example of a computational process, a given datacenter system may provide processing power for creating and maintaining the index (e.g., indexing operation). In another example, a given datacenter system may provide processing power for other “back end” processing that the operator configures it to perform.

Although the datacenter system 120 is depicted in FIG. 1 as a single entity, this does not need to be the case in each and every embodiment of the present technology. In other words, it is contemplated that the datacenter system 120 may distributed amongst distinct datacenter systems (possibly located in distinct datacenter facilities and/or different geographical areas) representing sub-clusters of computer systems, without departing from the scope of the present technology.

The datacenter system 120 is communicatively coupled to the triage server 106. It is contemplated that communication between the triage server 106 and the datacenter system 120 may be established with or without the communication network 110 and will depend on inter alia various implementations of the present technology. In some embodiments of the present technology, the triage server 106 and the datacenter system 120 may be part of a common datacenter facility.

### Triage Server

The system 100 also comprises the triage server 106 that can be implemented as a conventional computer server. In an example of an embodiment of the present technology, the triage server 106 can be implemented as a Dell™ PowerEdge™ Server running the Microsoft™ Windows Server™ operating system. Needless to say, the triage server 106 can be implemented in any other suitable hardware, software, and/or firmware, or a combination thereof. In the depicted non-limiting embodiments of the present technology, the triage server 106 is a single server. In alternative non-limiting embodiments of the present technology, functionalities of the triage server 106 may be distributed and/or may be implemented via multiple servers.

Generally speaking, the triage server 106 is configured to inter alia:
identify recent data associated with a given web page to be indexed;
generate an importance score for the given web page based on the recent data associated with the given web page; and
selectively add the given web page, based on a comparison between the importance score of the web page and a given triage threshold, to one of:
   (i) a given real-time indexing queue; and
   (ii) a given postponed indexing queue.

It is contemplated that, in order to execute at least some functionalities thereof, the triage server 106 may implement a crawler application 107, a Machine Learning Algorithm (MLA) 108 and a Load Balancing Algorithm (LBA) 109. The implementations of the crawler application 107, the MLA 108 and the LBA 109 will now be discussed in turn.

### Crawler Application

Generally speaking, a given crawler application, crawling application, or simply “crawler”, is typically used by search engines in order to browse the World Wide Web for the purpose of indexing. As such the crawler application 107 is configured to visit or browse various web pages available over the communication network 110 (e.g., such as the plurality of digital documents 104) at their respective URLs, and gather data representative of the various web pages for indexing. The gathering of data indicative of the various web pages is sometimes referred to as “fetching” where a sub-component of the crawler application 107, called a “fetcher”, is configured to download data, such as computer-executables files representative of the various web pages.

As such, the triage server 106 may be configured to implement the crawler application 107 in order to browse or visit web pages at their respective URLs and download data representative of the respective web pages for inter alia indexation purposes.

### Machine Learning Algorithm (MLA)

Generally speaking, MLAs can learn from and make predictions on data. MLAs are usually used to first build a model based on training inputs of data in order to then make data-driven predictions or decisions expressed as outputs, rather than following static computer-readable instructions. MLAs are commonly used for various prediction-like tasks based on some sets of features available as part of input data.

During training, a given MLA may receive a plurality of training sets comprising respective training vectors and respective labels. Training vectors are usually indicative of some features about a training entity while labels are usually indicative of an output that is, in a sense, “desirable” for the respective training vectors. Therefore, labels can be said to represent target results for the given MLA to output for respective training vectors. As a result, during in-use operation, if the given MLA receives a vector that is similar to a given training vector based on which it has been trained, the given MLA may provide an in-use output similar to the label of the given training vector.

To summarize, the implementation of the MLA 108 by the triage server 106 can be broadly categorized into two phases—a training phase and an in-use phase. First, the MLA 108 is trained in the training phase. Then, once the MLA 108 knows what data to expect as inputs and what data to provide as outputs, the MLA 108 is actually run using in-use data in the in-use phase.

It is contemplated that the triage server 106 may employ the MLA 108 during its in-use phase in order to generate importance scores for web pages. How the training sets for training the MLA 108 (e.g., training vectors and labels) are generated, how the MLA 108 is trained and how the MLA 108 is subsequently used during its in-use phase for generating importance scores will be discussed in greater detail herein below.

### Load Balancing Algorithm (LBA)

It should be noted that the processing load of the datacenter system 120 may be managed by the LBA 109 implemented by the triage server 106. Generally speaking, a given load balancing algorithm is configured to distribute or balance execution of computational processes across a number of computer systems. As such, in some embodiments of the present technology, the triage server 106 may be configured to perform “load balancing” operations which aim to optimize resource use (in this case, processing power resources provided by the datacenter system 120), minimize response time, and avoid overload of any processing power resource. Using multiple processing power resources (e.g., cluster(s) of computer systems of the datacenter system 120) with load balancing operations by the triage server 106, instead of a single computer system, may increase reliability and availability of data through redundancy, for example.

It is contemplated that the triage server 106 implementing the LBA 109 may keep track of the amount of computer processing power of the datacenter system 120 that is used in real-time for various back end processing and the amount of processing power of the datacenter system 120 that is available in real-time for indexing operation.

It is also contemplated that the triage server 106 implementing the LBA 109 may keep track of the amount of computer processing power of the datacenter system 120 that may be required at a later time for various back end processing and the amount of processing power of the datacenter system 120 that may be required at the later time for postponed indexing operation.

It is contemplated that, in some embodiments of the present technology, the LBA 109 may provide information to the triage server 106 in order to help in determining which ones of the plurality of digital documents 104 should be indexed in real-time and which ones should be postponed for indexing at a later time. What information the LBA 109 may provide to the triage server 106 and what the triage server 106 is configured to perform in response to this information will be described in greater detail herein below.

### Processing Database

The triage server 106 is also communicatively coupled to a processing database 124. In the depicted illustration, the processing database 124 is depicted as single physical entity. This does not need to be so in each and every embodiment of the present technology. As such, the processing database 124 may be implemented as a plurality of separate databases. Optionally, the processing database 124 may be split into several distributed storages.

The processing database 124 is generally configured to store information extracted or otherwise determined or generated by the triage server 106 during processing. Generally speaking, the processing database 124 may receive data from the triage server 106 which was extracted or otherwise determined or generated by the triage server 106 during processing for temporary and/or permanent storage thereof and may provide stored data to the triage server 106 for use thereof.

It is also contemplated that the processing database 124 may be configured to store data associated with various web pages. In one example, the processing database 124 may store data associated with web pages and which is representative of the computer-executable files representative of the respective web pages. In another example, the processing database 124 may be configured to, alternatively or additionally, store data associated with web pages and which is indicative of user interactions of users of a given search engine with the respective web pages. It is contemplated that data indicative of user interactions may be classified into different types of user interactions (and potentially stored under such classification in the processing database 124) such as, but not limited to: selection of a given web page as a search result, number of clicks once on the given web page, time spent on the given web page, “shares” of the given web page, “likes” of the given web page, and the like.

It should be understood that data associated with a given web page may change over time. It is contemplated that the processing database 124 may store time stamps associated with various data associated with web pages. This means that, for a given web page, the processing database 124 may be configured to store data associated with the given web page in accordance with a given timeline where various data that is associated with the given web page can be “mapped” or projected onto the given timeline based on the respective time stamps.

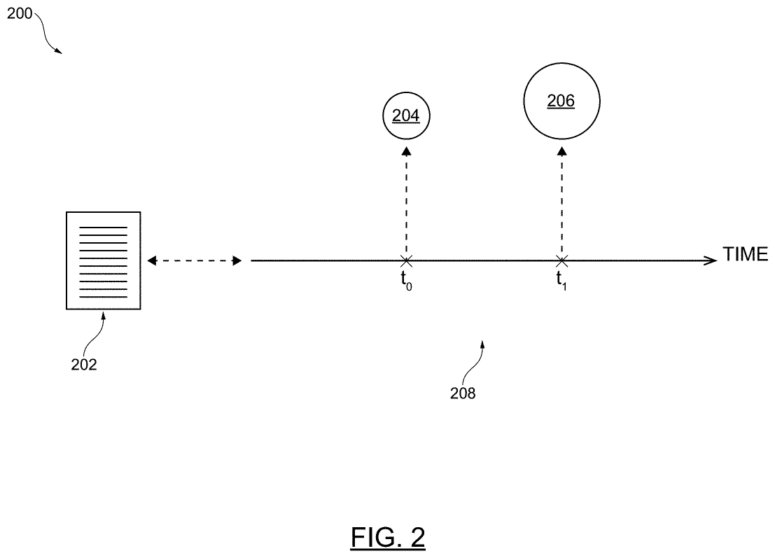

For example, with reference to FIG. 2, there is depicted a representation 200 of data associated with a given web page that may be stored in the processing database 124. There is depicted data 202 representative of the computer-executable files representative of the given web page. There is also depicted a timeline of at least some other data associated with the given web page.

A first set of data 204 is associated with the given web page and is indicative of all data that has been associated with the given web page until a moment in time t₀. A second set of data 206 is associated with the given web page and is indicative of all data that has been associated with the given web page until a moment in time t₁.

It is contemplated that the first set of data 204 may be at least partially included in the second set of data 206. However, the first set of data 204 does not include data which has been associated with the given web page during a time interval 208 and which data is included in the second set of data 206. It is contemplated that the data 202 may be included in at least one of or both of the first set of data 204 and the second set of data 206.

As a result, it can be said that the processing database 124 may store data associated with the given web page in such a manner that “knowledge” about how data associated with the given web page changed over time is available. In other words, it can be said that the processing database 124, not only may be configured to store data associated with the given web page, but may also be configured to store it such that “time drift” information indicative of the change (in time) of data associated with the given web page can be deduced or determined therefrom.

It is also contemplated that the processing database 124 may also store training data for training the MLA 108. The training data may comprise a plurality of training sets where each training set comprises (i) a respective training vector and (ii) a respective label associated with the respective training vector. Each training set is associated with a respective training web page having been (i) previously crawled (such as by the crawler application 107 of the triage server 106, for example), (ii) previously indexed in the index of a given search engine and (iii) previously provided as a search result to users of the given search engine.

How (i) the training vector and (ii) the label for a given training set (and for a given training web page) have been generated will now be discussed in turn.

For a given training web page, the respective training vector may have been generated by the triage server 106 (or some other server associated with the given search engine) based on data that has been already associated with the given training web page at a first moment in time after creation of content of the training web page. For example, the first moment in time after creation of content of the training web page may correspond to the moment in time at which the given training web page has been crawled by the crawler application 107 of the triage server 106 (or by some other crawler application of some other server associated with the given search engine).

It can be said that the respective training vector is representative of features of the given training web page at the first moment in time. For example, the respective training vector may be representative of features such as, but not limited to: creation time of the web page, various data counters associated with a respective URL (e.g., number of visits, number of inbound hyperlinks, number of outbound hyperlinks, number of logins and the like), type of content of the given training web page (news-type for example) determined by auxiliary systems of a given search engine based on content of the training web page, and the like. It should be understood that these features may be determined, directly or indirectly, from the data associated with the given training web page at the first moment in time.

It is to be noted that the data associated with the given training web page at the first moment in time is somewhat “limited” or “sparse” in the sense that, at the first moment in time, the given search engine has not yet used the given training web page as a search result for its users and, therefore, data indicative of user interactions of users of the given search engine with the training web page may not yet be available.

For the given training web page, the respective label may have been generated by the triage server 106 (or some other server associated with the given search engine) or assessed by a human assessor based on data that has been already associated with the given training web page at a second moment in time that is later in time than the first moment in time. For example, the second moment in time may correspond to a moment in time that is spaced away from the first moment in time by a pre-determined time interval. Length of the pre-determined time interval will depend on inter alia various implementations of the present technology.

However, it is contemplated that, at the second moment in time, the search engine may have already used the given training web page as a search result for its users and, therefore, at the second moment in time, the data associated with the training web page may now comprise data indicative of at least some user interactions of users of the given search engine with the training web page.

It should be understood that the respective label is indicative of usefulness of the given training web page as a search result and/or as a “fresh” search result. Indeed, the data associated with the given training web page may be analyzed by the triage server 106 (or some other server associated with the given search engine) or assessed by the human assessor in order to determine whether or not the given training web page was useful as a search result to the users of the search engine. For example, during the analysis or assessment (of the data associated with the given training web page at the second moment in time), at least some of the different types of user interactions associated with the training web page at the second moment in time may be taken into account for determining whether or not the given training web page was useful as a search result to the users of the search engine. The at least some of the different types of user interactions may include, but are not limited to: number of selections of the training web pages as a search result, rankings of the given training web pages when displayed as search results, number of clicks on the given training web pages, time spent on the given training web pages, and the like.

As a result, based on the analysis or assessment, if it is determined that the given training web page has been useful as a search result to users of the given search engine, the triage server 106 (or some other server associated with the given search engine) may generate, or the human assessor may assess, the respective label to be “1” or any other value indicating that the given training web page has been useful as a search result. Alternatively, based on the analysis or assessment, if it is determined that the given training web page has not been useful as a search result to users of the search engine, the triage server 106 (or some other server associated with the given search engine) may generate, or the human assessor may assess, the respective label to be “0” or any other value indicating that the given training web page has not been useful as a search result.

Without wishing to be bound to any specific theory, developers of the present technology appreciated that due to the “limited” or “sparse” data associated with a given web page at the first moment in time, it is a difficult task to correlate the data available at the first moment in time with possible future usefulness of the given web page. In other words, it is contemplated that the “limited” or “sparse” data associated with a given web page at the first moment in time is generally composed of data that is “time-independent”, while usefulness is generally deduced from data that is “time-dependent”.

To summarize, the processing database 124 (FIG. 1) may store training data for training the MLA 108. The training data may comprise the plurality of training sets where each training set is associated with a respective training web page. Each training set comprises (i) a respective training vector that has been generated based on data that has been associated with the training web page at the first moment in time and (ii) a respective label that has been generated based on data that has been associated with the training web page at the second moment in time being later in time than the first moment in time and where the respective label is indicative of usefulness of the respective training web page as a search result to users of the given search engine.

It should also be noted that in some embodiments of the present technology, it is contemplated that the plurality of training sets may be categorized into two categories—(i) “positive” training sets, which are associated with training web pages that have been determined to be useful as search results to users of the search engine and (ii) “negative” training sets, which are associated with training web pages that have been determined to not be useful as search results or otherwise not particularly useful as search results to users of the given search engine.

As previously alluded to, the triage server 106 implements the MLA 108 for generating importance scores for respective web pages. How the MLA 108 is trained and used by the triage server 106 for generating importance scores for respective web pages will now be discussed in turn.

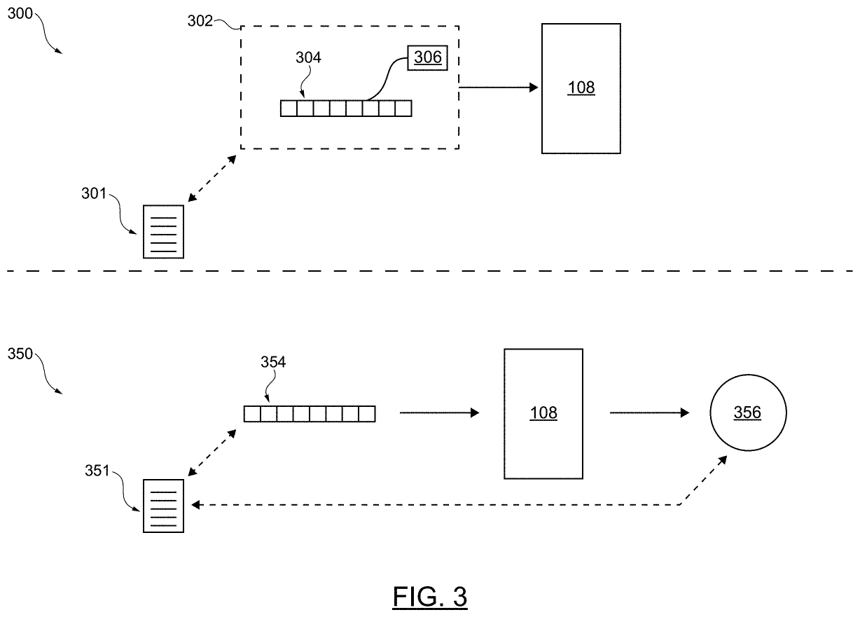

With reference to FIG. 3, there is depicted a single iteration 300 of the training phase of the MLA 108. Although there is depicted only one training iteration in FIG. 3, it should be understood that a large number of training iterations may be executed by the triage server 106 as part of the training phase of the MLA 108, similarly to how the single iteration 300 is executed by the triage server 106, without departing from the scope of the present technology.

As part of the single iteration 300, the triage server 106 may retrieve a training set 302 from the processing database 124. The training set 302 is associated with a training web page 301 and comprises a training vector 304 and a label 306, both associated with the training web page 301.

The triage server 106 is then configured to input the training set 302 into the MLA 108. It can be said that the MLA 108, in a sense, “learns” to correlate the training vector 304 to the label 306. In other words, it can be said that the MLA 108 “learns” that for the training vector 304, the “desired” value to be outputted is the label 306. As a result, the MLA 108 is trained such that, when it is inputted with a given vector that is similar to the training vector 304, it may generate a given output value similar to the label 306.

For example, if the training set 302 is a given positive training set (for example, the training web page 301 has been determined to be useful as a search result to users of the search engine and that the label 306 is “1”), the MLA 108 is trained such that, when it is inputted with a given in-use vector that is similar to the training vector 304, it may generate a given output value that is close to “1”.

In another example, if the training set 302 is a given negative training set (for example, the training web page 301 has been determined to not be useful as a search result to users of the search engine and that the label 306 is “0”), the MLA 108 is trained such that, when it is inputted with a given in-use vector that is similar to the training vector 304, it may generate a given output value that is close to “0”.

Therefore, it is contemplated that in some embodiments of the present technology, the MLA 108 is trained to estimate or predict the usefulness of a given in-use web page to users of the given search engine based on a given in-use vector associated with the given in-use web page that is generated based on “limited” or “sparse” data that is available at the moment in time when the given in-use web page is crawled.

It is contemplated that the MLA 108 may learn to estimate or predict the influence of the “time-independent” data of the given in-use web page on the “time-dependent” data of the given in-use web page. It is contemplated that the MLA 108 may learn to estimate or predict the influence of the “time-independent” data of the given in-use web page on the usefulness of the given in-use web page.

As mentioned above, once the MLA 108 has been trained, the triage server 106 is configured to employ the MLA 108 during its in-use phase to generate importance scores for respective in-use web pages.

In FIG. 3, there is also depicted a single iteration 350 of the in-use phase of the MLA 108. Although there is depicted only one in-use iteration in FIG. 3, it should be understood that the triage server 106 may execute an in-use iteration for each given in-use web page, similarly to how the single iteration 350 is executed by the triage server 106, without departing from the scope of the present technology.

As part of the single iteration 350, the triage server 106 may generate an in-use vector 354 for an in-use web page 351, similarly to how training vectors have been generated for training web pages.

Let it be assumed that the web page 351 is a given one of the plurality of digital documents 104 (see FIG. 1). As such, the triage server 106 may employ the crawler application 107 to crawl the web page 351 thereby acquiring recent data associated with the web page 351 at a given moment in time after the creation of content of the web page 351. It is contemplated that the given moment in time may correspond to a given moment in time after (possibly right after) the web page 351 has been crawled by the crawler application 107. Therefore, the triage server 106 may be configured to generate the in-use vector 354 for the web page 351 based on the recent data associated with the web page 351.

The triage server 106 is then configured to input the in-use vector 354 into the “now trained” MLA 108 which is configured to generate, in response, an in-use output value 356 that is representative of the importance score of the in-use web page 351. Hence, the importance score 356 (e.g., the in-use output value for the in-use vector 354) is indicative of the usefulness of the in-use web page 351 as a search result to user of the given search engine. It is contemplated that the importance score 356 may be a given value between “1” and “0”, for example, which is indicative of a probability of the in-use web page 351 to be useful as a search result to users of the given search engine.

In some embodiments of the present technology, the triage server 106 may be configured to employ the MLA 108 for generating importance scores for at least some of the plurality of digital documents 104, similarly to how the triage server 106 is configured to generate the importance score 356 for the in-use web page 351.

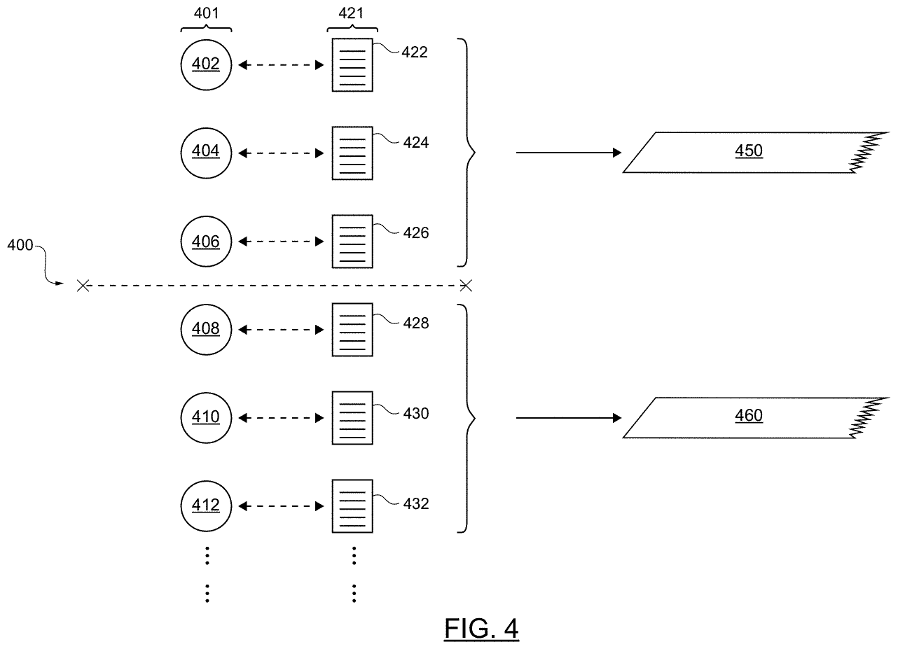

With reference to FIG. 4, there is depicted a plurality of importance scores 401 generated by the triage server 106 for a plurality of web pages 421 (e.g., at least some of the plurality of digital documents 104). It should be understood that the triage server 106 is configured to generate each one of the plurality of importance scores 401 after (possibly right after) the respective one of the plurality of web pages 421 has been crawled. In other words, it is contemplated that once the crawler application 107 has crawled a given web page, the generation of a respective importance score is executed in real-time.

For example, let it be assumed that the crawler application 107 has crawled a web page 426. The triage server 106 is then configured to generate an importance score 406 similarly to what has been described above. It is contemplated that, once the importance score 406 is generated, the triage server 106 is configured to compare the importance score 406 to a triage threshold 400 in order to selectively add the web page 426 to one of (i) a real-time indexing queue 450 for indexing the web page 426 in real-time and (ii) a postponed indexing queue 460 for postponing the indexing of the web page 426.

In some embodiments, the triage threshold 400 may be pre-determined by an operator of the given search engine, by an operator of the triage server 106 or by an operator of the datacenter system 120. In such a case, the triage threshold 400 is indicative of a “baseline usefulness” value of web pages that should be indexed in real-time.

In other embodiments of the present technology, the triage server 106 may employ the LBA 109 in order to determine the triage threshold 400. In some embodiments, the LBA 109 may be configured to determine the triage threshold 400 in real-time. How the triage server 106 is configured to employ the LBA 109 for determining the triage threshold 400 will now be described.

As previously mentioned, the triage server 106 may employ the LBA 109 in order to determine whether or not the datacenter system 120 has an available amount of processing power for executing real-time indexing (for example, in some cases all the processing power may be “used up” in real-time for other back end processing and the processing load is to high on the datacenter system 120 in real-time). In some embodiments, if it is determined that the datacenter system 120 indeed has an available amount of processing power for executing real-time indexing, the triage server 106 may employ the LBA 109 in order to determine what amount of processing power is actually available for executing the real-time indexing.

Once the amount of processing power that is available for executing real-time indexing is determined, the LBA 109 may be configured to “convert” the processing power units (amount thereof) that are available for real-time indexing into a value that is indicative of the triage threshold 400. In some embodiments, this conversion may be one of linear or proportional, logarithmic, exponential and the like and will depend on inter alia various implementations of the present technology.

However, it should be understood that if the triage server 106 employing the LBA 109 determines that the amount of processing power available for executing the real-time indexing has increased at a second given moment in time as compared to a first given moment in time, the triage server 106 employing the LBA 109 may determine that the triage threshold 400 at the second given moment in time should be lower than at the first given moment in time. Indeed, a lower triage threshold may result in a larger number of web pages being selectively added to the real-time indexing queue 450.

Conversely, it should be understood that if the triage server 106 employing the LBA 109 determines that the amount of processing power available for executing real-time indexing has decreased at the second given moment in time as compared to the first given moment in time, the triage server 106 employing the LBA 109 may determine that the triage threshold 400 at the second given moment in time should be higher than at the first given moment in time. Indeed, a higher triage threshold may result in a smaller number of web pages being selectively added to the real-time indexing queue 450.

Returning to the description of FIG. 4, let it also be assumed that the triage server 106 determines that the importance score 406 is above the triage threshold 400. As a result, the triage server 106 is configured to selectively add the web page 426 to the real-time indexing queue 450 for indexing the web page 426 in real-time.

Continuing with the same example, let it now be assumed that the crawler application 107 crawled a web page 428 (possibly after the web page 426). The triage server 106 is then configured to generate an importance score 408 similarly to what has been described above. It is contemplated that, once the importance score 408 is generated, the triage server 106 is configured to compare the importance score 408 to the triage threshold 400 in order to selectively add the web page 428 to one of (i) the real-time indexing queue 450 for indexing the web page 426 in real-time and (ii) the postponed indexing queue 460 for postponing the indexing of the web page 426.

Let it be assumed that the triage server 106 determines that the importance score 408 is below the triage threshold 400. As a result, the triage server 106 is configured to selectively add the web page 428 to the postponed indexing queue 460 for postponing the indexing the web page 428.

A same logic may be applied sequentially to each one of web pages 422, 424, 430 and 432 upon the crawler application 107 crawling the respective ones of the web pages 422, 424, 430 and 432. Let it be assumed that, as depicted in FIG. 4, the triage server 106 determines that importance score 402 and 404 are above the triage threshold 400 and importance score 410 and 412 are below the triage threshold 400. As a result, the triage server 106 may selectively add the web pages 422 and 424 to the real-time indexing queue 450 for indexing the web pages 422 and 424 in real-time. Also, the triage server 106 may selectively add the web pages 430 and 432 to the postponed indexing queue 460 for the postponed indexing of the web pages 430 and 432.

It should be understood that, since the selective addition of given web pages to one of (i) the real-time indexing queue 450 and (ii) the postponed indexing queue 460 is executed sequentially by the triage server 106, in some embodiments of the present technology, it is contemplated that web pages added to the real-time indexing queue 450 for indexing the web pages in real-time may be indexed independently from web pages added to the postponed indexing queue 460. This means that, in some embodiments of the present technology, web pages added to the postponed indexing queue 460 do not affect or influence the real-time indexing of web pages added to the real-time indexing queue 450.

It is contemplated that, in some embodiments of the present technology, the web pages in the real-time indexing queue 450 may be ordered by the triage server 106 according to their respective importance scores. It is also contemplated that the web pages in the postponed indexing queue 460 may be ordered by the triage server 106 according to their respective importance scores. This means that in some embodiments of the present technology, two given web pages in any one of (i) the real-time indexing queue 450 and (ii) the postponed indexing queue 460 are not ordered according to a same order in which they have been crawled by the crawler application 107 of the triage server 106.

In some embodiments of the present technology, the triage server 106 may also be configured to transmit data indicative of the web pages (crawled data) in the real-time indexing queue 450 to the datacenter system 120 for real-time indexing. Also the triage server 106 may also be configured to transmit data indicative of the web pages (crawled data) in the postponed indexing queue 460 to the datacenter system 120 for postponed indexing.

It should be understood that, while the triage server 106 may transmit the data indicative of the web pages in the real-time indexing queue 450 to the datacenter system 120 in real-time, this may not be the case for the transmission of the data indicative of the web pages in the postponed indexing queue 460. This means that, the transmission of the data indicative of the web pages in the postponed indexing queue 460 to the datacenter system 120 for postponed indexing may be executed (i) in real-time but for indexing at a later time or (ii) at a later time for indexing at some other later time.

As previously alluded to, in some embodiments of the present technology, the triage threshold 400 may be dependent on the available amount of processing power of the datacenter system 120 for executing real-time indexing. It is contemplated that in additional embodiments of the present technology, when the LBA 109 employed by the triage server 106 determines that the available amount of processing power of the datacenter system 120 has changed at a second given moment in time as compared to a given first moment in time, the triage server 106 may be configured to adjust the triage threshold 400 accordingly.

As a result, this may provide a scalable solution for dealing with limited amounts of processing power available at various datacenter systems. Indeed, different operators or entities may have different datacenter facilities providing different amounts of processing power for executing various back end processing and indexation operation. As such, adjustment of a given triage threshold in response to a change in amount of processing power available in real-time for executing indexation allows taking into account inherent limitations of different datacenter systems and may, therefore, be scalable for implementations into various datacenter systems.

In some embodiments of the present technology, upon adjustment of the triage threshold 400, the triage server 106 may “reconsider” which web pages should be selectively added to the real-time indexing queue 450 and which should be selectively added to the postponed indexing queue 460.

For example, let it be assumed that when the web page 428 has been crawled and the importance score 408 has been generated, the importance score 408 is below the triage threshold 400 and, as a result, the web page 428 is added to the postponed indexing queue 460. Now let it be assumed that, at a later moment in time, the LBA 109 employed by the triage server 106 determines that the available amount of processing power of the datacenter system 120 has increased and, as a result, at that later moment in time, the triage server 106 lowers the value of the triage threshold 400. Then, at the later moment in time, the triage server 106 may compare the importance score 408 of the web page 428 (which has been already selectively added to the postponed indexing queue 460) to the “now adjusted” lower value of the triage threshold 400. If the importance score 408 of the web page 428 is determined to be above the now adjusted lower value of the triage threshold 400, the triage server 106 may (i) selectively remove the web page 428 from the postponed indexing queue 460 and (ii) selectively add the web page 428 to the real-time indexing queue 450.

Such reconsideration by the triage server 106 may allow avoiding selective addition of a given web page to be bound to a time when the comparison between the respective importance score and the then value of the triage threshold 400 has occurred.

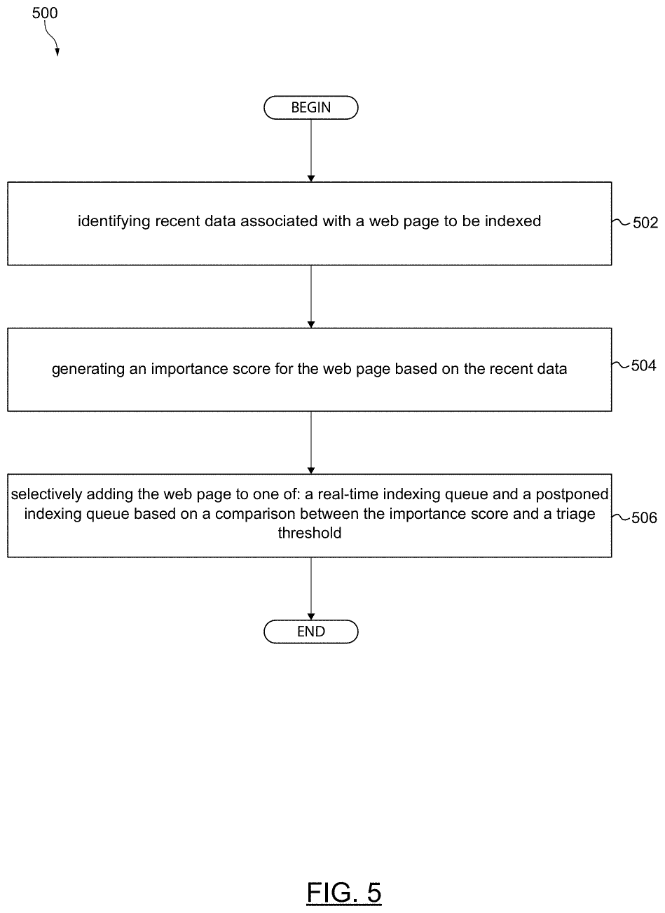

With reference to FIG. 5, there is depicted a method 500 of indexing a given web page. Various steps of the method 500 will now be described in greater detail.

Step 502: Identifying Recent Data Associated with a Web Page

The method 500 begins at step 502 with the triage server 106 identifying recent data associated with a given web page. The triage server 106 may execute the crawler application 107 in order to crawl a given web page from the plurality of digital documents 104.

In some embodiments, given web page may be either a given new web page or a given updated web page. The triage server 106 may in some cases determine whether the given web page is the given new web page or the given updated web page based on a comparison of the URL of the given web page with URL associated with web pages (old web pages) having been previously indexed.

For example, the given new web page may be a given web page that has not been previously indexed. It is contemplated that usefulness of the given new web page as a search result is more likely to be higher than usefulness of a given old web page as a search result where the given old web page has been previously indexed.

In another example, the given updated web page may be an updated version of a given old web page and where the given updated web page has not been previously indexed and where the given old web page has been previously indexed. It is contemplated that usefulness of the given updated web page as a search result is more likely to be higher than usefulness of the given old web page (old version) as a search result.

The recent data associated with the given web page may be associated with the given web page at a given moment in time after creation of content on the given web page. For example, the recent data may be associated with the given web page at a given moment in time after the given web page has been crawled by the crawler application 107.

The recent data may comprise, but not limited to: creation time of the given web page, number of visits to a URL of the given web page, number of inbound hyperlinks to the given web page, number of outbound hyperlinks from the given web page and type of content of the given web page. It is contemplated that at least some of the recent data of the given web page may be based on, determined from or be part of the crawled data of the given web page.

### Step 504: Generating an Importance Score for the Web Page Based on the Recent Data

The method 500 continues to step 504 with the triage server 106, by executing the MLA 108, generating a respective importance score for the given web page based on the recent data associated with the given web page.

For example, let it be assumed that the given web page is the web page 426 (see FIG. 4) and, as such, the MLA 108 generates the importance score 406. The importance score 406 is indicative of usefulness of the web page 426 as a search result and/or as a new search result for users of a given search engine. It is contemplated that, in some embodiments of the present technology, the importance score 406 is indicative of usefulness of the web page 426 as a fresh search result to users of a given search engine.

It should be understood that usefulness of fresh content to users of a given search engine usually (i) peaks close to the moment of its creation and (ii) drops after some period of time. Conversely, it should be understood that usefulness of stagnant content to users of the given search engine usually (i) is lower near the moment of its creation than usefulness of fresh content near the moment of its creation but (ii) is somewhat constant over time.

Therefore, in some embodiments of the present technology, determining usefulness of given web pages as fresh results may allow selective prioritization of web pages with fresh content for real-time indexation since the usefulness peaks earlier or, in other words, web pages with fresh content might be useful to users only near the moment of their creation. For instance, a news article about a breaking news regarding some very recent event such as “All patent agent trainees of a firm passed their patent agent qualification exams”, for example, might be useful to users of a given search engine only near the moment of creation of the news article.

With reference to FIG. 3, there is depicted the single iteration 300 of the training phase of the MLA 108. The MLA 108 may be trained based on the training set 302 associated with the training web page 301. The training set 302 comprises the training vector 304 and the label 306.

The training vector 304 is indicative of data associated with the training web page 301 at a given first moment in time after creation of content on the training web page 301. For example, the given first moment in time may correspond to a moment in time when the training web page 301 has been crawled. As previously mentioned, “limited” or “sparse” data may be available at the first given moment in time when the given training web page 301 is crawled.

It should be understood that the label 306 is indicative of usefulness of the training web page 301 as a search result (or in other embodiments, as a fresh search result). Indeed, the data associated with the training web page 301 may be analyzed by the triage server 106 or assessed by the human assessor in order to determine whether or not the training web page 301 was useful as a search result (or alternatively as a fresh search result) to the users of the search engine. For example, during the analysis or assessment, at least some of the different types of user interactions associated with the training web page 301 at a given second moment in time may be taken into account for determining whether or not the training web page 301 was useful as a search result (or alternatively as a fresh search result) to the users of the given search engine. The at least some of the different types of user interactions may include, but are not limited to: number of selections of the training web page 301 as a search result (and/or as a fresh search result), rankings of the given training web page 301 when displayed as a search result (and/or as a fresh search result), number of clicks on the given training web page 301, time spent on the training web page 301, and the like.

### Step 506: Selectively Adding the Web Page to One of a Real-Time Indexing Queue and a Postponed Indexing Queue Based on a Comparison Between the Importance Score and a Triage Threshold

The method 500 ends at step 506 with the triage server 106 selectively adding the given web page to one of (i) the real-time indexing queue 450 and (ii) the postponed indexing queue 460 based on a comparison between the respective importance score the triage threshold 400.

For example, let it be assumed that the given web page is the web page 426 and the respective importance score 406 is compared to the triage threshold 400. If the importance score 406 is below the triage threshold 400, the web page 426 is added to the postponed indexing queue 460 for postponing the indexing of the web page 426. If the importance score 406 is above the triage threshold 400, the web page 426 is added to the real-time indexing queue 450 for indexing of the web page in real-time.

In some embodiments of the present technology, web pages added to the real-time indexing queue for indexing the web pages in real-time are indexed independently from web pages added to the postponed indexing queue. This means that, in some embodiments of the present technology, importance scores of web pages added to the postponed indexing queue 460 do not affect or influence the real-time indexation of web pages added to the real-time indexing queue 450.

In other embodiments of the present technology, it is contemplated that web pages added to the real-time indexing queue 450 for indexing the web pages in real-time are indexed before any other web page added to the postponed indexing queue 460. As a result, web pages added to the real-time indexing queue 450 are selectively prioritized for indexing to web pages added to the postponed indexing queue 460.

In further embodiments of the present technology, in response to the triage server 106 determining that the given web page is a given new web page, the triage server 106 may either (i) directly assign an importance score of “1” thereto or (ii) assign a weight to the respective importance score generated therefor by the MLA 108 to ensure that it is above the triage threshold 400. This means that new web page may be added to the real-time indexing queue 450 for indexation in real-time and, thus, selectively prioritized for indexation to other web pages.

In some embodiments of the present technology, the triage server 106 may transmit data (crawled data) indicative of web pages in the real-time indexing queue 450 to the datacenter system 120 for real-time indexing. It is also contemplated that the triage server 106 may transmit data (crawled data) indicative of the web pages in the postponed indexing queue 460 to the datacenter system 120 for postponed indexing.

In other embodiments of the present technology, the triage server 106 may implement the LBA 109 for balancing processing load of the datacenter system 120. It is contemplated that the triage server 106 may employ the LBA 109 for determining that the datacenter system 120 has an available amount of processing power for executing real-time indexing.

Also, as explained above, the triage threshold 400 (the value thereof) may be dependent on the available amount of processing power for executing real-time indexing as determined via the LBA 109. It is contemplated that in response to determining, by the triage server 106 employing the LBA 109, that the available amount of processor power for executing real-time indexing has changed, the triage server 106 may adjust the value of the triage threshold 400 as described above.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method of indexing a web page in an index, the index being hosted in a datacenter system communicatively coupled with a triage server, the index for providing indications of possible search results to a search engine, the method executable by the triage server, the method comprising:
identifying, by the triage server executing a crawler application, recent data associated with the web page to be indexed;
generating, by the triage server executing a machine learning algorithm (MLA), an importance score for the web page based on the recent data associated with the web page, the importance score being indicative of usefulness of the web page as a search result, the MLA having been trained based on a training set comprising:
(i) a training vector indicative of data associated with a training web page at a first moment in time after creation of content on the training web page; and
(ii) a label indicative of usefulness of the training web page as a search result and based on data associated with the training web page at a second moment in time, the second moment in time being later in time than the first moment in time;
selectively adding, by the triage server, the web page to one of (i) a real-time indexing queue and (ii) a postponed indexing queue based on a comparison between the importance score of the web page and a triage threshold such that:
if the importance score is below the triage threshold, the web page is added to the postponed indexing queue for postponing the indexing of the web page; and
if the importance score is above the triage threshold, the web page is added to the real-time indexing queue for indexing of the web page in real-time.

2. The method of claim 1, wherein the recent data is associated with the web page at a given moment in time after creation of content on the web page.

3. The method of claim 1, wherein the recent data is associated with the web page at a given moment in time after the web page has been crawled by the crawler application.

4. The method of claim 1, wherein the importance score is indicative of usefulness of the web page as a fresh search result.

5. The method of claim 1, wherein the training vector is based on sparse data associated with the training web page available at the first moment in time.

6. The method of claim 1, wherein web pages added to the real-time indexing queue for indexing the web pages in real-time are indexed independently from web pages added to the postponed indexing queue.

7. The method of claim 1, wherein web pages added to the real-time indexing queue for indexing the web pages in real-time are indexed before any other web page added to the postponed indexing queue.

8. The method of claim 1, wherein web pages added to either one of (i) a real-time indexing queue and (ii) postponed indexing queue are queued with respect to one another according to their respective importance scores.

9. The method of claim 1, wherein the web page is one of:
a new web page; and
an updated web page.

10. The method of claim 9, wherein the new web page is a given web page that has not been previously indexed, usefulness of the new web page as the search result being more likely higher than usefulness of an old web page as the search result, the old web page having been previously indexed.

11. The method of claim 9, wherein the updated web page is an updated version of an old web page, the updated web page has not been previously indexed, the old web page having been previously indexed, usefulness of the updated web page as the search result being more likely higher than usefulness of the old web page as the search result.

12. The method of claim 7, wherein in response to the web page being the new web page, the importance score is weighted to ensure it is above the triage threshold, such that the new web page is added to the real-time indexing queue for indexing of the new web page in real-time.

13. The method of claim 1, wherein the method further comprises:
transmitting, by the triage server, data indicative of the web pages in the real-time indexing queue to the datacenter system for real-time indexing; and
transmitting, by the triage server, data indicative of the web pages in the postponed indexing queue to the datacenter system for postponed indexing.

14. The method of claim 1, wherein the triage server implements a load balancing algorithm for balancing processing load of the datacenter system, and wherein the method further comprises:
determining, by the triage server employing the load balancing algorithm, that the datacenter system has an available amount of processing power for executing real-time indexing.

15. The method of claim 14, wherein the triage threshold is dependent on the available amount of processing power for executing real-time indexing.

16. The method of claim 14, wherein in response to determining, by the triage server employing the load balancing algorithm, that the available amount of processor power for executing real-time indexing has changed, adjusting, by the triage server, the triage threshold.

17. The method of claim 1, wherein the recent data comprises at least one of:
creation time of the web page;
number of visits to a URL of the web page;
number of inbound hyperlinks to the web page;
number of outbound hyperlinks from the web page; and
type of content of the web page.

18. A server for indexing a web page in an index, the index being hosted in a datacenter system communicatively coupled with the server, the index for providing indications of possible search results to a search engine, the server being configured to execute a crawler application and a machine learning algorithm (MLA), the server being configured to:
identify, by executing the crawler application, recent data associated with the web page to be indexed;
generate, by executing the MLA, an importance score for the web page based on the recent data associated with the web page, the importance score being indicative of usefulness of the web page as a search result, the MLA having been trained based on a training set comprising:
(i) a training vector indicative of data associated with a training web page at a first moment in time after creation of content on the training web page; and
(ii) a label indicative of usefulness of the training web page as a search result and based on data associated with the training web page at a second moment in time, the second moment in time being later in time than the first moment in time;
selectively add the web page to one of (i) a real-time indexing queue and (ii) a postponed indexing queue based on a comparison between the importance score of the web page and a triage threshold such that:
if the importance score is below the triage threshold, the web page is added to the postponed indexing queue for postponing the indexing of the web page; and
if the importance score is above the triage threshold, the web page is added to the real-time indexing queue for indexing of the web page in real-time.

19. The server of claim 18, wherein the triage threshold is dependent on an available amount of processing power of the datacenter system for executing real-time indexing.

20. The server of claim 18, wherein the web page is one of:
a new web page; and
an updated web page.
